(19) United States
(12) Patent Application Publication
(10) Pub. No.: US 2007/0138205 A1
(43) Pub. Date: Jun. 21, 2007

(54) On demand drink dispenser

(75) Inventor: Kurt M. D'Aurizio, Myrtle Beach, SC (US)

Correspondence Address: Kurt M. D'Aurizio, 812 Abalone Court, Myrtle Beach, SC, 29579, US

(73) Assignee: Kurt M. D'Aurizio, Myrtle Beach, SC (US)

(21) Appl. No.: 11/305,860

(22) Filed: Dec. 19, 2005

(51) Int. Cl. B67D 5/62

(52) U.S. Cl. 222/146.6

(57) ABSTRACT

A refrigerated beverage dispenser that can be stored on a countertop or installed in a new or existing home refrigerator. A storage area holds one or more beverages, in original containers such as a gallon milk jug or non-original container. A dispensing system includes tubing and a pump to move the beverage from the container to a spout into desired glass or beverage vessel. A trigger pad activates the dispensing of the beverage. An optional display on the front of the unit could identify the beverage(s) that are currently being stored and dispensed. An optional catch well can retrieve any drips or spills while dispensing.

### RELATED APPLICATIONS

The present application is a continuation-in-part application of U.S. provisional patent application, Ser. No. 60/636,914, filed Dec. 16, 2004, for BEVERAGE DISPENSER, by D'Aurizio M. Kurt, Myrtle Beach, S.C., included by reference herein and for which benefit of the priority date is hereby claimed.

### FIELD OF THE INVENTION

The present invention relates to the field of beverage coolers and dispensers, and more particularly to counter top on-demand beverage dispensing devices.

### BACKGROUND OF THE INVENTION

It was the summer of 2004, and my six year old son had been getting himself a glass of milk when he accidentally spilled the gallon of milk on the floor. I began thinking of how to create an appliance that would allow any six year old to get themselves a drink without making a mess.

Typically, cold beverages are stored in a refrigerator and poured out of original containers. However, this can lead to difficulty if many things are stored in the refrigerator. Some households purchase separate refrigeration for beverages but keep them in a garage or other inconvenient location. Also, it is difficult for some people, especially young children and the elderly, to pour beverages from large containers. Therefore, there has been a need for a device that can store a variety of refrigerated beverages with a convenient dispensing mechanism.

In the prior art, several devices have been designed to fill this need. For example, U.S. Pat. No. 4,913,318 to Forrester describes a portable beverage heater, cooler and dispenser. Also, a device for cooling or heating a liquid incorporating a fan for heat exchange is shown in U.S. Pat. No. 4,274,262 to Reed et al. Meanwhile, U.S. Pat. No. 4,880,535 to Burrows discloses a system for storing beverages at specific temperatures. Further, U.S. Pat. Nos. 4,866,945, 5,469,708 and 4,757,920 to Bender et al., Harrison et al., and Harootian, Jr. et al., respectively, disclose coolers for commercially available 2.5-gallon water bottles.

However, none of these devices have a refrigeration system and a pump for dispensing beverages from their containers. Although U.S. Pat. No. 5,771,709 to Smith describes a counter top beverage dispenser, which has a refrigerator unit, a pump and a temperature control display, this device can only dispense one beverage at a time and requires beverage to be poured from original container into cooling well, making cleaning difficult.

Therefore, there is still a long felt need for an improved beverage cooler and dispenser. This need includes the combination on refrigeration, easy dispensing, portability, and ease of cleaning leading to maintaining food safety.

It is therefore an object of the invention to provide a means to easily dispense cold beverages

It is another object of the invention to allow unit to be moved to any area and plugged in to standard wall socket.

It is another object of the invention to keep beverages safely refrigerated

It is another object of the invention to dispense beverages easily for all people, including children or elderly, by simply pressing glass on pressure switch mechanism

### SUMMARY OF THE INVENTION

In accordance with the present invention, there is provided a refrigerated beverage dispenser that can be stored on a countertop or installed in a new or existing home refrigerator. A storage area holds one or more beverages, in original containers such as a gallon milk jug or non-original container. A dispensing system includes tubing and a pump to move the beverage from the container to a spout and into desired drinking vessel. A trigger pad activates the dispensing of the beverage. An optional display on the front of the unit could identify the beverage(s) that are currently being stored and dispensed. An optional catch well can retrieve any drips or spills while dispensing.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front perspective view of a beverage dispenser in accordance with the invention;

FIG. 2 is a top perspective view of a top of beverage dispenser with pumps and tubing; and

FIG. 3 is a front view of a front of beverage dispenser with door open.

For purposes of clarity and brevity, like elements and components will bear the same designations and numbering throughout the Figures.

### DESCRIPTION OF THE PREFERRED EMBODIMENT

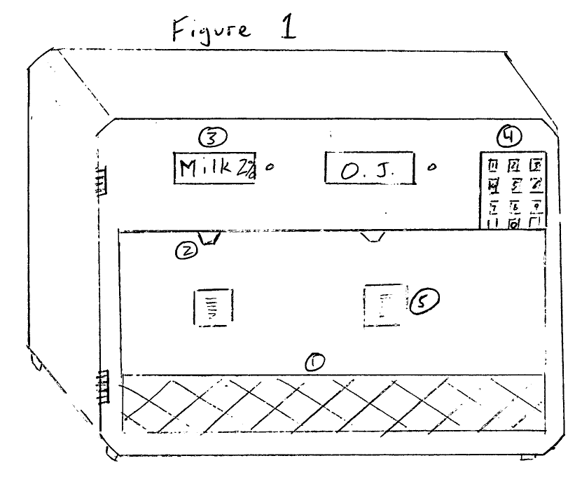

FIG. 1 is a front perspective view of a beverage dispenser in accordance with the invention.

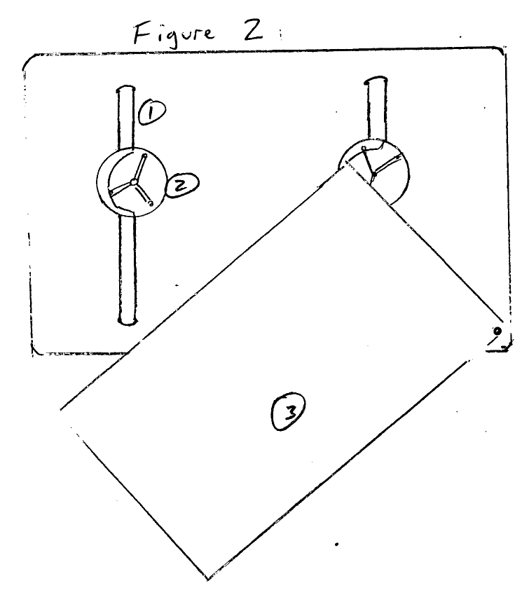

FIG. 2 is a top perspective view of a top of beverage dispenser with pumps and tubing.

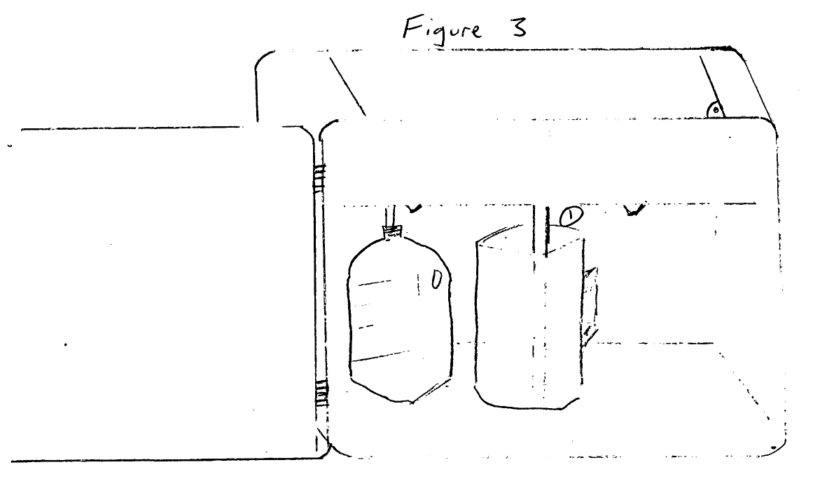

FIG. 3 is a front view of a front of beverage dispenser with Door 24 open.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An on demand drink dispenser for refrigerating and dispensing beverages, comprising:
means for to activate pumps and dispense beverages;
means for dispensing beverages;
means for transporting beverages, removably connected to said means for dispensing beverages;
means for moving liquid from container to beverage drinking glass or vessel, frictionally connected to said means for transporting beverages, and electrically connected to said means for to activate pumps and dispense beverages;
means for to allow beverages to be placed in refridgerated area; and
means for chilling beverages to safe temperature and holding beverages at safe temperature.

2. The on demand drink dispenser in accordance with claim 1, wherein said means for to activate pumps and dispense beverages comprises a pump switch (FIG. 1 #5).

3. The on demand drink dispenser in accordance with claim 1, wherein said means for dispensing beverages comprises a removable, washable dispensing spouts (FIG. 1 #2).

4. The on demand drink dispenser in accordance with claim 1, wherein said means for transporting beverages comprises a removable, washable tubing (FIG. 2 #1).

5. The on demand drink dispenser in accordance with claim 1, wherein said means for moving liquid from container to beverage drinking glass or vessel comprises a pump (FIG. 2 #2).

6. The on demand drink dispenser in accordance with claim 1, wherein said means for to allow beverages to be placed in refridgerated area comprises a door.

7. The on demand drink dispenser in accordance with claim 1, wherein said means for chilling beverages to safe temperature and holding beverages at safe temperature comprises a refridgeration system.

8. An on demand drink dispenser for refrigerating and dispensing beverages, comprising:
a pump switch (FIG. 1 #5), for to activate pumps and dispense beverages;
a removable, washable dispensing spouts (FIG. 1 #2), for dispensing beverages;
a removable, washable tubing (FIG. 2 #1), for transporting beverages, removably connected to said dispensing spouts (FIG. 1 #2);
a pump (FIG. 2 #2), for moving liquid from container to beverage drinking glass or vessel, frictionally connected to said tubing (FIG. 2 #1), and electrically connected to said Pump switch (FIG. 1 #5);
a door, for to allow beverages to be placed in refridgerated area; and
a refridgeration system, for chilling beverages to safe temperature and holding beverages at safe temperature.

9. The on demand drink dispenser as recited in claim 8, further comprising:
a changeable identification displays (FIG. 1 #3), for to identify beverages being dispensed.

10. The on demand drink dispenser as recited in claim 8, further comprising:
a numbered keypad (FIG. 1 #4), for to change identification displays or temperature settings.

11. The on demand drink dispenser as recited in claim 9, further comprising:
a numbered keypad (FIG. 1 #4), for to change identification displays or temperature settings.

12. An on demand drink dispenser for refrigerating and dispensing beverages, comprising:
a pump switch (FIG. 1 #5), for to activate pumps and dispense beverages;
a changeable identification displays (FIG. 1 #3), for to identify beverages being dispensed;
a numbered keypad (FIG. 1 #4), for to change identification displays or temperature settings;
a removable, washable dispensing spouts (FIG. 1 #2), for dispensing beverages;
a removable, washable tubing (FIG. 2 #1), for transporting beverages, removably connected to said dispensing spouts (FIG. 1 #2);
a pump (FIG. 2 #2), for moving liquid from container to beverage drinking glass or vessel, frictionally connected to said tubing (FIG. 2 #1), and electrically connected to said Pump switch (FIG. 1 #5);
a door, for to allow beverages to be placed in refridgerated area; and
a refridgeration system, for chilling beverages to safe temperature and holding beverages at safe temperature.
